(19) United States
(12) Patent Application Publication
(10) Pub. No.: US 2003/0036894 A1
(43) Pub. Date: Feb. 20, 2003

(54) Method and apparatus for amortizing critical path computations

(76) Inventor: William Lam, Fremont, CA (US)

Correspondence Address: ROSENTHAL & OSHA L.L.P. / SUN, 1221 MCKINNEY, SUITE 2800, HOUSTON, TX, 77010, US

(21) Appl. No.: 09/990,935

(22) Filed: Nov. 15, 2001

Related U.S. Application Data
(60) Provisional application No. 60/313,763, filed on Aug. 20, 2001.

(51) Int. Cl. G06F 17/50

(52) U.S. Cl. 703/19

(57) ABSTRACT

The present invention provides a method and apparatus for amortizing critical path computation. According to an embodiment of the present invention, a digital circuit design is simulated using cycle based simulation techniques. The digital circuit design is represented by a data flow graph. In the data flow graph are one or more critical paths and one or more shortest paths. The data flow graph representing the digital circuit design is unrolled into a plurality of simulation cycles. Thereafter, the multiple cycle graph is scheduled to a plurality of processing units, thereby simulating several cycles at once. In one embodiment, communication latency is relaxed by delaying the arrival times of external inputs within the unrolled cycles. In another embodiment, the unrolled circuit allows for scheduling compaction. The present invention provides for improved simulation speed by better balancing the workload among multiple processing units in the system.

Applicant hereby claims priority to Provisional Application No. 60/313,763 filed on Aug. 20, 2001.

### BACKGROUND OF THE INVENTION

1. Field of the Invention

The present invention relates to a method and apparatus for amortizing critical path computations.

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

2. Background Art

It is expensive to design and manufacture electronic circuits, especially digital circuits. Therefore, to ensure that a digital design produces the appropriate results it is very important for electronic hardware designers to thoroughly test and analyze it prior to manufacturing it. One analysis method involves the simulation of a digital system using computer software in a “cycle based” simulation.

Current cycle based simulation schemes, as it is further explained below, are inefficient and exacting on simulation resources, especially when a digital system has a complex design. Specifically, simulations run slowly when there is a large difference between a “critical path” and a “shortest path” in the digital circuit design.

Cycle based simulation of a circuit in a multi-processing environment requires representing the digital circuit design in a data structure such as a directed acyclic graph (DAG) and scheduling the nodes of the graph for computation by individual processing units. A DAG is a pair (V,E), where V is a finite set and E is a binary relation on V. The set V is called the vertex set of G, and its elements are called vertices. The set E is called the edge set of G, and its elements are called edges.

FIG. 10 is a pictorial representation of a DAG on the vertex set {1,2,3,4,5,6}. Vertices are represented by circles in the figure, and edges are represented by arrows. A traversal of the DAG of FIG. 10 is represented by an ordered pair. For instance {4,1} represents the traversal along the edge connecting vertices 4 and 1. When each processing unit performs its respective computations, it performs a traversal of a path in the DAG. The paths will vary in length, and hence, will take differing amounts of time to compute for each processing unit. In a cycle based simulation, however, all logic elements must be computed in each cycle, so shorter paths will complete during a cycle causing their respective processing units to remain idle, while the longest paths (critical paths) will take the entire cycle to be computed.

A method is needed that can more effectively balance the workload of the multiple processing units in a computing environment (i.e., amortize critical path computations). Problems relating to cycle based simulation of digital systems can be better understood from a general description of digital electronics, the design of digital systems, and cycle based simulation schemes, provided below.

Digital Circuit Design

Many modem equipment and appliances such as computers, radios, televisions, telephones, etc., exploit digital electronics and circuitry to operate. As such, the efficient design and manufacture of electronic/digital circuits is very important. Digital circuits are data pathways designed according to the rules of Boolean logic. Boolean logic deals with the logical relationships between data signals produced by electronic elements of a circuit that operate by accepting and processing binary information (i.e., zeros and ones).

In designing digital circuits (also referred to as chips), it is desirable to achieve high reliability and a balance between production cost and system performance. Therefore, designers and manufacturers utilize various tools such as computer aided design (CAD) systems, or other simulation software to implement, test, and evaluate the digital architecture of a circuit to ensure correctness before incurring the time and expense of fabricating a physical prototype.

One use of the software simulators is to assist a chip designer in evaluating a given circuit design by varying the parameters (e.g., input signals) of the system. Simulation is used to improve the accuracy and the speed of digital analysis and to refine the choice of device parameters in design work

In the design and simulation of digital systems, a hardware design, such as a computer or a component of a computer, is often described or modeled in a Hardware Description Language (HDL), such as Verilog or Very High Speed Integrated Circuit Hardware Description Language for example. Once a system is described in a HDL, the HDL description may be simulated in hardware, such as by programming a FPGA (field-programmable gate array) device based on the HDL description, or the HDL description maybe rendered or compiled into a software construct for execution on one or more processors. A designer is then able to simulate the HDL model or description to confirm logical functionality prior to, for example, committing to the expensive process of chip fabrication.

Cycle Based Simulation

Cycle based simulation is applicable to synchronous digital systems and may be utilized to verify the functional correctness of a digital design. Cycle based simulators use algorithms that eliminate unnecessary calculations to achieve improved performance in verifying system functionality. Typically, in a cycle based simulator the entire system is evaluated once at the end of each clock cycle. Therefore, discrete component evaluations and re-evaluations are unnecessary upon the occurrence of every event.

FIG. 1A is a block diagram of a digital circuit with various components A, B, and C, and clock triggered flip-flops F1 and F2. A flip-flop is a digital memory device capable of alternating (i.e., flip-flopping) between two Boolean values (zeros and ones) based on the value of a data input signal. The output generated by a flip-flop is synchronized in relation with a specified clock event (i.e., a rising edge). D1 and D2 represent the input signals to flip-flops F1 and F2, respectively.

Digital clocks are used to synchronize the operation of various circuit components by generating sequential digital signals. FIG. 1B illustrates the state diagrams for clocks C(1) and C(2) used to synchronize the digital circuit of FIG. 1A. Digital clocks are individual timing devices that generate a uniform electrical frequency from which digital pulses are created. The uniformly sequential clock pulses are used to synchronize different events and functions within a circuit.

In a cycle based simulation, a digital circuit is evaluated at each clock cycle regardless of any events that may have occurred within that cycle. A clock cycle refers to the period between one clock signal and the next. Referring to FIG. 1B, the state diagram of clock C(1) enclosed between vertical lines 0 and 3, represents a clock cycle for clock C(1). Thus, referring to FIG. 1A, in a cycle based simulation, the circuit components such as combinatorial logic A, B, and C are evaluated based on the value generated by F1 and F2 at the end of each clock cycle.

Cycle Based Simulation Using HDLs

In software simulation, the HDL description is executed as multiple concurrent processes (typically very large in number) by a computer or other processor-based system. The HDL description typically models processes with reference to a fixed time interval or simulation unit (e.g., integer values in nanoseconds). For a synchronous design, those logic processes may be controlled by a single master clock. The master clock is used to define the simulation cycle. Simulation is carried out by stepping through the simulation cycle, executing every process exactly once during a given simulation unit interval before proceeding to the next simulation cycle.

From a register transfer level (RTL) design standpoint, an HDL design comprises a network of sequential logic components. (e.g., registers) that are clocked at each simulation cycle, with zero or more combinatorial logic components between each set of adjacent sequential logic components. In this view, cycle-based simulation involves evaluating all intervening combinatorial logic components between a first register's (or other sequential logic component's) output pin and a second register's input pin, to determine the new state to be stored in the second register at the beginning of the next simulation cycle. During each simulation cycle, this evaluation is carried out globally on all combinatorial logic sections of the design to determine the next state for all sequential logic components in the design.

Critical Paths

In a computing environment having multiple processing units executing in each clock cycle, a scheduling process must occur so that each processing unit has a balanced workload. The digital circuit design is normally represented by a DAG with sequential nodes before combinatorial nodes. A DAG comprises a set of edges and a set of nodes. An edge represents a dependancy and a node represents a computation. A node is ready to be evaluated when all of its fanins are ready. When all nodes are computed, a simulation cycle is complete.

The DAG is termed herein a data flow graph. The data flow graph has a plurality of nodes, and the nodes are scheduled to processing units as determined by a scheduling algorithm. In each clock cycle, the simulation system must perform traversals of the data flow graph to evaluate every digital logic element represented therein.

Within the data flow graph will be traversal lengths that differ in size. The traversal lengths are termed a path. In every data flow graph, there will be a shortest path, where the minimum amount of computations must occur within a given clock cycle to traverse the data flow graph. The total simulation time of a simulation cycle is determined by a longest path length in the data flow graph. the longest path is termed a critical path.

Oftentimes, there is a large difference between the shortest path and the critical path in the data flow graph. With data flow graphs where there is a large difference between the shortest path and the critical path, simulation time is not optimal in the prior art because when the simulation is performed, the processing units computing the nodes along the critical path will work continually throughout the simulation cycle, while the processing units computing the nodes along the shortest path will complete their computations within the clock cycle and remain idle for the remainder of the cycle.

One prior art solution is to move computations to the idling processing units, so that for each simulation cycle, processing unit load is more equally balanced throughout all of the processing units in the system. This solution is disadvantageous because of communication latency. Communication latency refers to the cost of inter-processing unit communications. When nodes along a path are shifted to new processing units, such shifts require the processing units to communicate the results of their computation. Communicating the results of the computation between processing units causes the processing units to execute additional instructions during the simulation, which increases simulation time.

Oftentimes, shifting work to idling CPUs causes such a large communication latency that the speed of the simulation is increased when compared to a straightforward scheduling scheme where processing units with short path computations remain idle for portions of a simulation cycle. Since the time a simulation can be carried out is of primary importance in building a simulation system, prior art solutions are not adequate. A method and apparatus is needed that will amortize critical path computations in both a simulation system and in a general purpose multi-processing computer.

### SUMMARY OF THE INVENTION

The present invention provides a method and apparatus for amortizing critical path computations. According to an embodiment of the invention, a digital circuit design is simulated using cycle based simulation techniques. In cycle based simulation, all elements of the digital circuit design are evaluated exactly once in each clock cycle.

The digital circuit design is represented by a DAG called a data flow graph. In the data flow graph are one or more critical paths and one or more shortest paths. The critical path is the path traversing the data flow graph, where the maximum amount of computations must occur within a given clock cycle. The shortest path is the path traversing the data flow graph, where the minimum amount of computations must occur within a given clock cycle.

When there is a large difference between a shortest path and a critical path in a clock cycle, some of the processing units in the computer system will remain idle for a portion of the clock cycle. To minimize idling processors during the clock cycles in a cycle based simulation, the workload of the multiple processing units are balanced as follows:

1) The data flow graph representing the digital circuit design is unrolled into a plurality of simulation cycles; and

2) The multiple cycle graph is scheduled to a plurality of processing units, thereby simulating several cycles at once.

By unrolling the circuit into a multiple cycle evaluation, the differences between critical and shortest paths are reduced, for instance by removing the needs for digital logic elements, such as flip-flops and latches, at the boundaries of the original clock cycles before unrolling, and by feeding critical and non-critical paths to the same processing unit during an unrolled clock cycle. By minimizing the differences between critical and shortest path through a multiple cycle evaluation, processing unit idling is reduced (i.e., the workload between processing units is more evenly balanced).

In one embodiment, communication latency is relaxed by delaying the arrival times of external inputs within the unrolled cycles. In another embodiment, the unrolled circuit allows for scheduling compaction. The invention results in a faster execution time, which is a primary goal when building a simulation system or on any multi-processing computer.

### BRIEF DESCRIPTION OF THE DRAWINGS

These and other features, aspects and advantages of the present invention will become better understood with regard to the following description, appended claims and accompanying drawings where:

FIG. 1A is a block diagram illustrating a digital circuit including flip-flops.

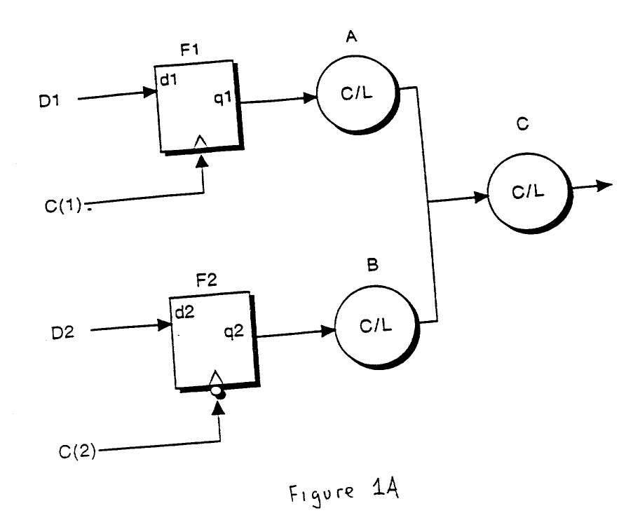

FIG. 1B is a state diagram illustrating non-overlapping clocks C(1) and C(2).

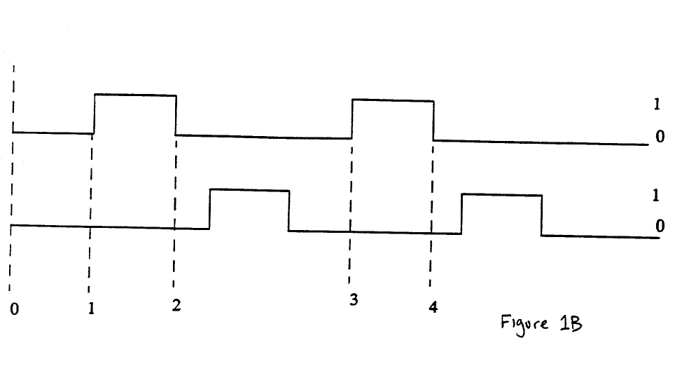

FIG. 2 illustrates a subcluster of processing units.

FIG. 3 illustrates a chip.

FIG. 4 is a block diagram of a chip array.

FIG. 5A is a diagram of a digital circuit that can be simulated in a single cycle.

FIG. 5B is the digital circuit of FIG. 5A unrolled into two clock cycles according to one embodiment of the present invention.

FIG. 6 is the digital circuit of FIG. 5B which has undergone communication latency relaxation according to one embodiment of the present invention.

FIG. 7 shows a possible scenario where idle time slots are filled by nodes from another cycle.

FIG. 8 is a flowchart of critical path computation amortization according to one or more embodiments of the present invention.

FIG. 9 is a block diagram illustrating a computer execution environment in a general purpose computer, according to an embodiment of the invention.

FIG. 10 is a pictorial representation of a directed acyclic graph.

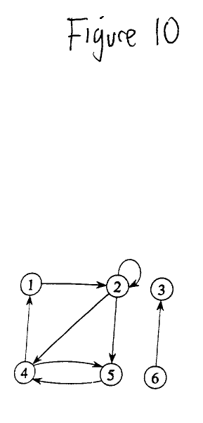

### DETAILED DESCRIPTION OF THE INVENTION

The invention is a method and apparatus for amortizing critical path computations. In the following description, numerous specific details are set forth to provide a more thorough description of embodiments of the invention. It is apparent, however, to one skilled in the art, that the invention may be practiced without these specific details. In other instances, well known features have not been described in detail so as not to obscure the invention.

Before further describing a method and apparatus for amortizing critical path computations, an embodiment of the hardware of a simulation system is described in more detail.

Simulation System Hardware Embodiment

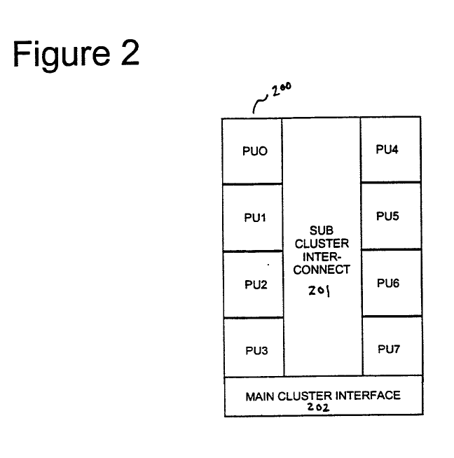

The processing units of one embodiment of a simulation system are grouped in a subcluster consisting of 8 processing units. FIG. 2 illustrates a subcluster of processing units. The subcluster 200 includes eight processing units identified as PU0-PU7 in FIG. 2. The processing units communicate locally through subcluster interconnect 201. The subcluster itself communicates with other subclusters through a main cluster interface (MCI) 202. Data to and from the processing units is controlled by routing tables. The routing table may include an instruction that for this cycle, there is data from the processing unit that is to be sent to another processing unit. This may not happen each cycle. Similarly, the routing table may include an instruction to read data for use by a processing unit.

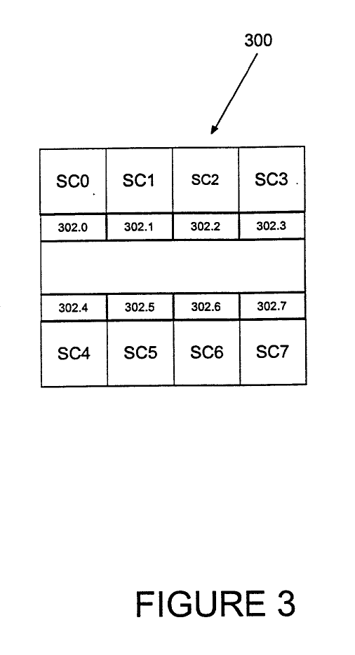

One embodiment of the simulation system provides a chip 300 consisting of 8 subclusters (i.e. 64 processing units) and is illustrated in FIG. 3. There are 8 subclusters identified as SC0-SC7. Each of the subclusters SC0-SC7 are connected to the chip interconnect through MCI's 302.0-302.7 respectively.

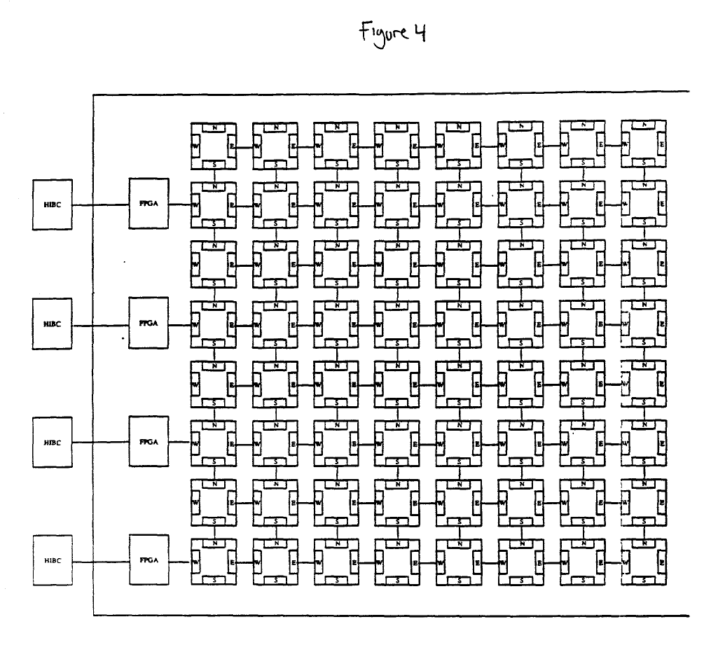

FIG. 4 illustrates a board consisting of 64 chips in an 8×8 array. Each chip 300 is connected to its four nearest neighbors except the edge chips. The simulation hardware in one embodiment of the simulation system consists of one or more boards, each capable of communicating with each other.

The processors communicate with each other through an interconnect network. In one embodiment, the connections are processor to processor, sub-cluster to sub-cluster, chip to chip, and board to board. The routing tables referred to above are used to control the transfer of data in the system using the interconnect network. Because data only moves one connection at a time each cycle, the processors are assigned so that where possible, minimum length connection paths can be established.

The chips are directly connected to four other chips. There may be instances where a data message must be transmitted to a processor more than one link away. The static routing schedule takes this into account. The system includes wait registers to hold data messages cycle by cycle until they can be delivered at destination processors. The above-described embodiment results in a system that is optimized for implementing RTL level operations and processing of HDL.

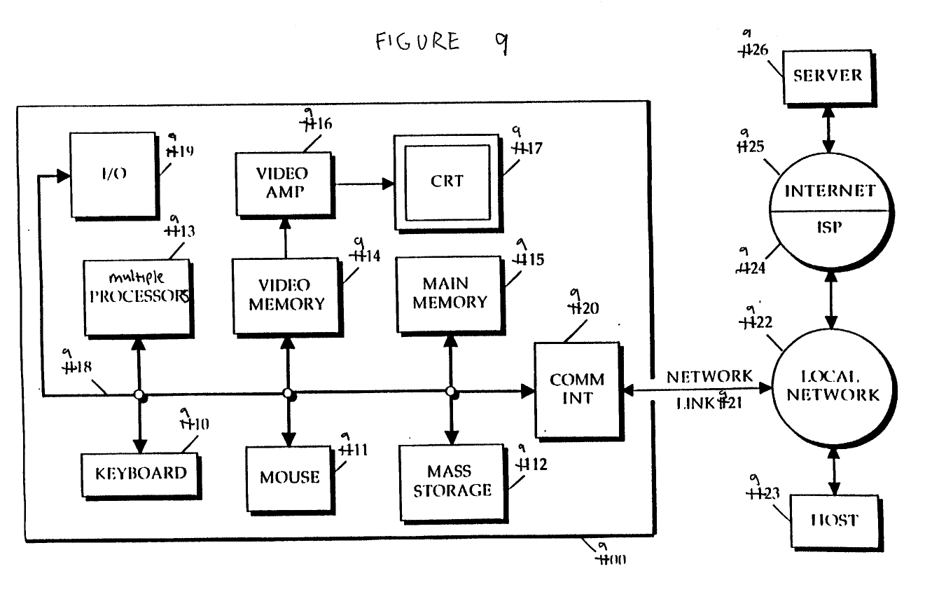

The above-described embodiment of a simulation system is described in further detail in co-pending U.S. patent application entitled “Method and Apparatus for Logic Simulation” Ser. No. ______, filed on ______, assigned to the assignee of the present application, and hereby fully incorporated into the present application by reference. The above described embodiment of a simulation system is for the purpose of example only. One skilled in the art should note that a method and apparatus for amortizing critical path computations can be embodied in any type of computing environment having multiple processing units including the general purpose computer system described in connection with FIG. 9.

Critical Path Computation Amortization

According to an embodiment of the invention, a digital circuit design is simulated using cycle based simulation techniques. In cycle based simulation, all elements of the digital circuit design are evaluated exactly once in each clock cycle.

The digital circuit design is represented by a data flow graph. In the data flow graph are one or more critical paths and one or more shortest paths. The critical path is the path traversing the data flow graph, where the maximum amount of computations must occur within a given clock cycle. The shortest path is the path traversing the data flow graph, where the minimum amount of computations must occur within a given clock cycle.

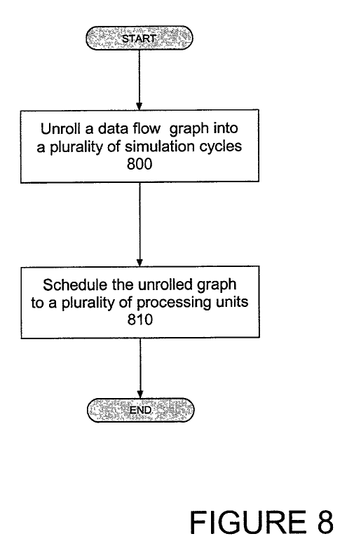

To alleviate the disadvantages associated with having a large difference between a shortest path and a critical path in a clock cycle (i.e., idling processing units), the workload of the multiple processing units are balanced as shown in FIG. 8.

The data flow graph representing the digital circuit design is unrolled into a plurality of simulation cycles (step 800). Thereafter, the multiple cycle graph is scheduled to a plurality of processing units (step 810), thereby evaluating all logic elements of the circuit in a multi-clock cycle.

Example of Circuit Unrolling

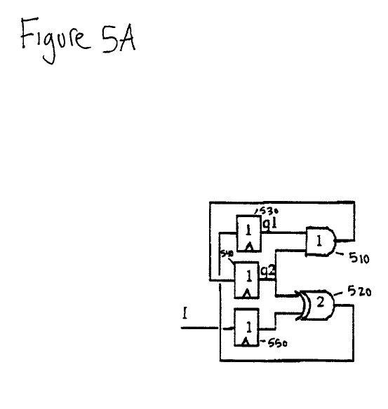

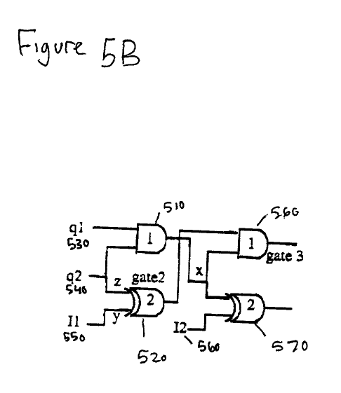

FIG. 5A is an example of a digital circuit that can be simulated in a cycle in accordance with one or more embodiments of the present invention. FIG. 5A includes AND gate 510, XOR gate 520, and flip-flops 530, 540, and 550. The number inside each gate represents the number of processing unit instructions needed to simulate the gate. The runtime of the circuit of FIG. 5A is six instructions: one instruction for each of flip-flops 530-550, two instructions for XOR gate 520, and one instruction for AND gate 510.

In FIG. 5A, two critical paths exist, for example. A first critical path flows through flip-flop 550 and XOR gate 520. A second critical path flows through flip-flop 540 and XOR gate 520. The critical paths are three instructions, for instance, one instruction for flip-flop 550 and two instructions for XOR gate 520. An example of a shortest path is the data path from flip-flop 530 through AND gate 510, which only requires two instructions.

Thus, there is a difference of one instruction between the critical and shortest paths in FIG. 5A. One should note that this example is trivial for simplicity. In practice, the critical and shortest path difference will ordinarily be much larger. Referring again to FIG. 5A, a single cycle simulation will cause an unevenly balanced load on the processing units causing the processing unit assigned to the path represented by flip-flop 530 and AND gate 510 to idle for one instruction while the critical path is computed in a given cycle, thereby wasting the idling processing unit's capability of performing an instruction during that time period and slowing down the overall speed of the simulation.

FIG. 5B represents the digital circuit of FIG. 5A after being unrolled into two clock cycles. FIG. 5B includes AND gates 510 and 560, XOR gates 520 and 570, flip-flops 530, and 540, and external inputs 550 and 560. The runtime for FIG. 5B is ten instructions: one instruction for each of flip-flops 530 and 540, one for each of external inputs 550 and 560, two instructions for XOR gates 520 and 570, and one instruction for AND gates 510 and 560.

In FIG. 5B, one critical paths flows through external input 550, XOR gate 520 and AND gate 560, for example. The critical path in this example is four instructions, for instance, one instruction for external input 550, two instructions for XOR gate 520, and one instruction for AND gate 560. Since the circuit of FIG. 5B has been unrolled into two cycles, the four instruction critical path represents a two instruction critical path per cycle. Hence, the critical path of the unrolled circuit of FIG. 5B has been shrunk to two instructions per cycle, from three instructions per cycle in FIG. 5A. Note that flip-flops 530, 540, and 550 can be eliminated at the boundary between the first and second cycle of FIG. 5B. The result is that the difference between the critical and shortest paths in FIG. 5B have been eliminated and no processing units will idle when simulating this circuit.

It has been shown that for a given critical path in a simulation cycle X, it is likely to add to a non-critical path in a simulation cycle X+1, which is the next cycle. The critical path length in an N-cycle data flow graph can never be longer than N times the critical path length in a cycle, specifically when critical paths are fed back into non-critical paths. Likewise, the shortest path in an N-cycle graph is always shorter than N times the shortest path in a cycle. By unrolling a data flow graph and amortizing the critical paths, the difference between long and short paths is reduced. Hence, the multiple processing units of the simulation system have a better balanced load. Once the load is balanced, the reduced critical paths are computed over N cycles resulting in a faster overall simulation.

Digital Logic Element Elimination

When multiple cycles are expanded in accordance with an embodiment of the present invention, digital logic elements, such as flip-flops or latches in the design can be replaced by their combinational equivalent. For a D flip-flop, its combinational equivalent is a wire, for example. In general, the combinational equivalent of a flip-flop or latch is the Boolean function relating inputs to outputs. Elimination of registers or flip-flops across cycle boundaries can cause a significant reduction in overall simulation time and a significant improvement in simulation resource utilization, specifically if such flip-flops constitute a large percentage of the size of the digital circuit design.

The number of flip-flops can be estimated as follows. Let L be the number of flip-flops, and N be the number of levels of logic. The number of gates in the circuit can be approximated to N. Therefore, the percentage of flip-flops can be approximated to 1/N. In a typical circuit design, the number of levels of logic is approximately 10-12. So, unrolling a cycle saves approximately 10% in runtime due to flip-flop elimination.

Communication Latency Relaxation

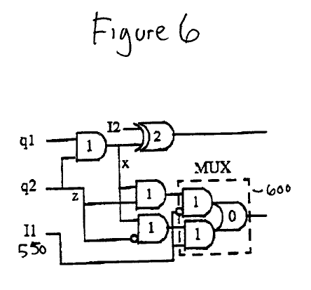

When simulating a digital circuit timing constraints exist. It is more difficult to simulate a digital circuit if the arrival time of external inputs are required to arrive earlier. It is easier to simulate a digital circuit if the arrival time of external inputs are allowed to arrive later. Thus, when a digital circuit design is simulated in a multiple processor environment, the latency constraints on the network can be reduced by delaying the arrival time requirements for external inputs. With reference to FIG. 5B, external input 550 can be re-constructed to its position in FIG. 6. FIG. 6 is the digital circuit of FIG. 5B which has undergone communication latency relaxation according to an embodiment of the present invention. External input 550 is re-synthesized to a later time, relieving a communication constraint. XOR gate 520 and AND 110 gate 560 of FIG. 5B have been collapsed to MUX 600 and external input 550 has been moved to the output, which relaxes the required time.

XOR gate 520 and AND gate 560 have been re-synthesized as:

f=x*(y^{H}_{J}z)=[(x*z)*⁹₈y]+[(x*⁹₈z)*y]

The synthesis is shown in FIG. 6. Thus, external input 550 is delayed by one time unit. The delay of external input 550 is only possible in an unrolled cycle expansion because it implements a cross boundary node collapsing technique (i.e., it combines XOR gate 520 in cycle one and AND gate 560 in cycle 2).

Scheduling Compaction

By unrolling a circuit into multiple cycles, the advantages of scheduling compaction can be gained in one embodiment of the present invention. Nodes from a first cycle can be scheduled with nodes from a second or other cycles. This re-scheduling allows the present invention to fill holes (i.e., processor idling times) that would exist in a single cycle schedule.

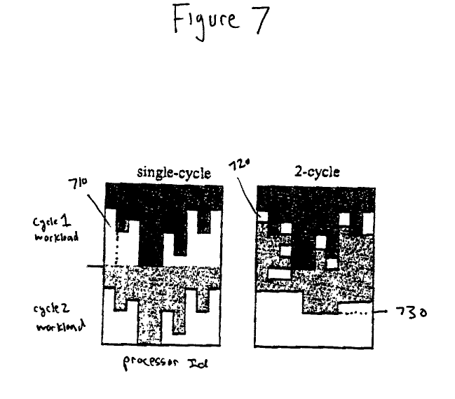

FIG. 7 shows a possible scenario where idle time slots are filled by nodes from another cycle, thus reducing the overall execution time of the simulation. In both graphs of FIG. 7 the vertical axis represents processing unit workload while the horizontal axis represents processing unit ID. The single cycle graph shows execution over two sequential cycles. Note in area 710, the processing unit represented by this graph is idling the majority of the cycle.

The right graph represents a two cycle unrolling and scheduling compaction of the left graph. In this example, the idling time of the same processing unit is drastically reduced as shown by the area 720. By scheduling critical path computations in short path processing units as shown on the right, the entire logic design portrayed by FIG. 7 is simulated in the time shown in area 730. If compaction occurred beyond two cycles, processors could begin executing at area 730 of the right graph, instead of area 740 of the left graph, thereby reducing overall simulation time.

Intermediate Value Determination

Multiple cycle simulation masks some intermediate values. In one embodiment, if a user wants to determine the values of all internal nodes at a given cycle N, the following procedure maybe implemented. First the circuit can be simulated at a M-cycle expansion, where M is a single cycle short of N. Next, a single cycle is simulated to reach N. That is: N cycles=[N/M] “M cycle simulation” followed by (the remainder of N/M) “single cycle simulation”.

For a given circuit, there may be an optimal M that yields the best computation to communication ratio, the most relaxed communication restriction, and the shortest runtime. As far as longest runtime is concerned, the following can be used to estimate speedup using an M cycle expansion. Let P′ be the longest path in an M cycle expansion. Let P be the longest path in a single cycle circuit. Let each flip-flop require one instruction. Then, simulate C cycles using single cycle and M cycle circuits having the following runtimes:

single cycle:(1+P)*C

M-cycle:(1/M+P′/M)*C

Embodiment of Computer Execution Environment (Hardware)

An embodiment of the invention can be implemented as computer software in the form of computer readable code executed on a general purpose computer such as computer 900 illustrated in FIG. 9, or in the form of bytecode class files running on such a computer. A keyboard 910 and mouse 911 are coupled to a bi-directional system bus 918. The keyboard and mouse are for introducing user input to the computer system and communicating that user input to processor 913. Other suitable input devices may be used in addition to, or in place of, the mouse 911 and keyboard 910. I/O (input/output) unit 919 coupled to bi-directional system bus 918 represents such I/O elements as a printer, A/V (audio/video) I/O, etc.

Computer 900 includes a video memory 914, main memory 915 and mass storage 912, all coupled to bi-directional system bus 918 along with keyboard 910, mouse 911 and multiple processors 913. The mass storage 912 may include both fixed and removable media, such as magnetic, optical or magnetic optical storage systems or any other available mass storage technology. Bus 918 may contain, for example, thirty-two address lines for addressing video memory 914 or main memory 915. The system bus 918 also includes, for example, a 32-bit data bus for transferring data between and among the components, such as processors 913, main memory 915, video memory 914 and mass storage 912. Alternatively, multiplex data/address lines may be used instead of separate data and address lines.

In one embodiment of the invention, the processors 913 are microprocessors manufactured by Motorola, such as the 680×0 processor or a microprocessor manufactured by Intel, such as the 80×86, or Pentium processor, or a SPARC microprocessor from Sun Microsystems, Inc. However, any other suitable microprocessor or microcomputer may be utilized. Main memory 915 is comprised of dynamic random access memory (DRAM). Video memory 914 is a dual-ported video random access memory. One port of the video memory 914 is coupled to video amplifier 916. The video amplifier 916 is used to drive the cathode ray tube (CRT) raster monitor 917. Video amplifier 916 is well known in the art and maybe implemented by any suitable apparatus. This circuitry converts pixel data stored in video memory 914 to a raster signal suitable for use by monitor 917. Monitor 917 is a type of monitor suitable for displaying graphic images.

Computer 900 may also include a communication interface 920 coupled to bus 918. Communication interface 920 provides a two-way data communication coupling via a network link 921 to a local network 922. For example, if communication interface 920 is an integrated services digital network (ISDN) card or a modem, communication interface 920 provides a data communication connection to the corresponding type of telephone line, which comprises part of network link 921. If communication interface 920 is a local area network (LAN) card, communication interface 920 provides a data communication connection via network link 921 to a compatible LAN. Wireless links are also possible. In any such implementation, communication interface 920 sends and receives electrical, electromagnetic or optical signals which carry digital data streams representing various types of information.

Network link 921 typically provides data communication through one or more networks to other data devices. For example, network link 921 may provide a connection through local network 922 to local server computer 923 or to data equipment operated by an Internet Service Provider (ISP) 924. ISP 924 in turn provides data communication services through the world wide packet data communication network now commonly referred to as the “Internet” 925. Local network 922 and Internet 925 both use electrical, electromagnetic or optical signals which carry digital data streams. The signals through the various networks and the signals on network link 921 and through communication interface 920, which carry the digital data to and from computer 900, are exemplary forms of carrier waves transporting the information.

Computer 900 can send messages and receive data, including program code, through the network(s), network link 921, and communication interface 920. In the Internet example, remote server computer 926 might transmit a requested code for an application program through Internet 925, ISP 924, local network 922 and communication interface 920.

The received code maybe executed by processors 913 as it is received, and/or stored in mass storage 912, or other non-volatile storage for later execution. In this manner, computer 900 may obtain application code in the form of a carrier wave.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. An embodiment of the invention may be implemented in any type of computer system or programming or processing environment.

Thus, a method and apparatus for amortizing critical path computations is described in conjunction with one or more specific embodiments. The invention is defined by the claims and their full scope of equivalents.

1. A method for amortizing a critical path computations in a circuit comprising:
unrolling a data flow graph representing said circuit into a plurality of clock cycles; and
simulating said circuit in said plurality of clock cycles on a computer.

2. The method of claim 1, wherein said step of simulating further comprises:
reducing a difference between said critical path and a shortest path in said data flow graph.

3. The method of claim 2, wherein said step of reducing further comprises:
compacting one or more computations from said plurality of clock cycles in a processor.

4. The method of claim 2, wherein said step of unrolling further comprises:
eliminating one or more flip-flops between one or more boundaries within said plurality of clock cycles.

5. The method of claim 2, wherein said step of unrolling further comprises:
eliminating one or more latches between one or more boundaries within said plurality of clock cycles.

6. The method of claim 1, wherein said computer has a plurality of processors.

7. The method of claim 1, wherein said computer has a plurality of simulation processors, wherein said simulation processors include a communication network interconnecting said simulation processors for data communication, said simulation processors further including a synchronization network interconnecting said simulation processors for synchronizing execution therebetween.

8. The method of claim 1, wherein said step of simulating further comprises:
delaying evaluation of one or more logic elements within said plurality of clock cycles, thereby creating a timing slack for inter-processor communication.

9. The method of claim 3, wherein said step of reducing further comprises:
using a first processor wherein said processor computes said critical path and a non-critical path in a said plurality of clock cycles.

10. The method of claim 1, further comprising:
compacting said plurality of clock cycles into a single clock cycle.

11. A critical path computation amortizer for a circuit comprising:
a data flow graph unroller configured to represent said circuit into a plurality of clock cycles; and
a simulator configured to simulate said circuit in said plurality of clock cycles on a computer.

12. The critical path computation amortizer of claim 11, wherein said simulator further comprises:
a reducer configured to reduce a difference between said critical path and said shortest path.

13. The critical path computation amortizer of claim 12, wherein said reducer further comprises:
a compactor configured to compact one or more computations from said plurality of clock cycles in a processor.

14. The critical path computation amortizer of claim 12, wherein said unroller further comprises:
an eliminator configured to eliminate one or more flip-flops at one or more boundaries within said plurality of clock cycles.

15. The critical path computation amortizer of claim 12, wherein said unroller further comprises:
an eliminator configured to eliminate one or more latches at one or more boundaries within said plurality of clock cycles.

16. The critical path computation amortizer 11, wherein said computer has a plurality of processors.

17. The critical path computation amortizer of claim 11, wherein said computer has a plurality of simulation processors, wherein said simulation processors include a communication network interconnecting said simulation processors for data communication, said simulation processors further including a synchronization network interconnecting said simulation processors for synchronizing execution therebetween.

18. The critical path computation amortizer of claim 11, wherein said simulator is further configured to delay evaluation of one or more logic elements in said plurality of clock cycles, thereby creating a timing slack for inter-processor communication.

19. The critical path computation amortizer of claim 13, wherein said reducer further comprises:
a feed-back configured to use a first processor wherein, said first processor computes said critical path and a non-critical path in said plurality of clock cycles.

20. The critical path computation amortizer of claim 11, further comprising:
a scheduling compactor configured to compact said plurality of clock cycles into a single clock cycle.

21. A computer program product comprising:
a computer usable medium having computer readable program code embodied therein configured to amortize a critical path computation in a circuit, said computer program product comprising:
computer readable code configured to cause a computer to unroll a data flow graph representing said circuit into a plurality of clock cycles; and
computer readable code configured to cause a computer to simulate said circuit in said plurality of clock cycles on a computer.

22. The computer program product of claim 21, wherein said computer readable code configured to cause a computer to simulate further comprises:
computer readable code configured to cause a computer to reduce a difference between said critical path and said shortest path.

23. The computer program product of claim 22, wherein said computer readable code configured to cause a computer to reduce further comprises:
computer readable code configured to cause a computer to compact one or more computations from said plurality of clock cycles in a processor.

24. The computer program product of claim 12, wherein said computer readable code configured to cause a computer to unroll further comprises:
computer readable code configured to cause a computer to eliminate one or more flip-flops at one or more boundaries within said plurality of clock cycles.

25. The computer program product of claim 12, wherein said computer readable code configured to cause a computer to unroll further comprises:
computer readable code configured to cause a computer to eliminate one or more latches at one or more boundaries within said plurality of clock cycles.

26. The computer program product of claim 21, wherein said computer has a plurality of processors.

27. The computer program product of claim 21, wherein said computer has a plurality of simulation processors, wherein said simulation processors include a communication network interconnecting said simulation processors for data communication, said simulation processors further including a synchronization network interconnecting said simulation processors for synchronizing execution therebetween.

28. The computer program product of claim 21, wherein said computer readable code configured to cause a computer to simulate further comprises:
computer readable code configured to cause a computer to delay evaluation of one or more logic elements in said plurality of clock cycles, thereby creating a timing slack for inter-processor communication.

29. The computer program product of claim 20, wherein said computer readable code configured to cause a computer to reduce further comprises:
computer readable code configured to cause a computer to use a first processor wherein said first processor computes said critical path and a non-critical path in said plurality of clock cycles.

30. The computer program product of claim 21, further comprising:
computer readable code configured to cause a computer to compact said plurality of clock cycles into a single clock cycle.
